(19) United States
(12) Patent Application Publication
(10) Pub. No.: US 2003/0178855 A1
(43) Pub. Date: Sep. 25, 2003

(54) Serial-wound power regenerating device

(76) Inventor: Ching-Huang Li, Yi-Lan City (TW)

Correspondence Address: BRUCE H. TROXELL, SUITE 1404, 5205 LEESBURG PIKE, FALLS CHURCH, VA, 22041, US

(21) Appl. No.: 10/103,875

(22) Filed: Mar. 25, 2002

(51) Int. Cl. H02P 9/04; F03B 13/00; F03B 13/10

(52) U.S. Cl. 290/43

(57) ABSTRACT

The present invention is a power regenerating device comprising of a hollow pressure cabin with an exhaust valve and a pressure gauge, one or more sets of suction devices at the inlet of the pressure cabin, and a set of windmill generators at the outlet of the pressure cabin, in which the set of windmill generators is composed of multi fan-type windmill generators connected in series. Once the air enters into the pressure cabin through the suction devices, the control valve at the outlet will be opened and the pressed air will flow out through the outlet to drive the windmill generators, which in turn revolve and generate electric power, and output the power to the collecting bar and then to the rectifier. The power generating capacity of this regenerator depends oil the demand. Because the power generated from each windmill generator is multiple times of that consumed by corresponding air suction devices, multiple regenerated power can be acquired from a small amount of power consumed, which not only is very economically beneficial, but also can implement self-sufficiency and eliminate the environmental pollution.

### FIELD OF THE INVENTION

After the air is driven into the pressure cabin through the suction devices, it passes through the control valve and enters into the set of windmill generators. The air, which is compressed, drives the fans to revolve and generate power. Then, the power generated from these windmill generators is exported to the collecting bar, rectified at the rectifier, and sent to the electric network. The power generating capacity depends on the actual demand.

### BACKGROUND OF THE INVENTION

The power consumed by the air suction devices depends on the figure preset for the set of windmill generators in series. Furthermore, it varies little, mo matter how many windmill generators are deployed. However, the sum of power generated from the windmill generators is multiple time of the power consumed, which is beneficial in economy.

The main purpose of this invention is to implement a serial-wound power-regenerating device, which input the air into the pressure cabin with the air suction devices and send the compressed air through the control valve to drive the fans of windmill generators, which in turn generates power and send the power to the collecting bar. Due that the total sum of power generated is multiple time of the power consumed by the air suction devices, this invention not only is very beneficial in economy, but also can implement self-sufficiency and eliminate environmental pollution.

Another purpose of this invention is to implement a serial-wound power regenerating device in which the pressure cabin is equipped with an exhaust valve and a pressure release capacity that can release redundant air when the pressure in the pressure cabin reaches or exceeds the upper threshold to ensure the safety of this device.

Another purpose of this invention is to implement a serial-wound power-regenerating device in which there is a manhole with a cover on the power regenerating unit to facilitate maintenance personnel doing maintenance and reparation work.

Another purpose of this invention is to implement a serial-wound power-regenerating device in which there is a control valve at the outlet and the inlet of the pressure cabin respectively. When the control valve at the inlet is closed, the air in the pressure cabin can't leak out; and when the one at the outlet is open, maintenance personnel can go into the power-regenerating unit to perform maintenance and reparation work.

### DETAILED DESCRIPTION OF THE EMBODIMENTS

The embodiments are illustrated and detailed as follows:

FIG. 1 is the exploded view of this invention, which demonstrates that the power-regenerating device (100) comprises of an airproof pressure cabin (5) with a pressure gauge (4) and an exhaust valve (6), one or more sets of air suction devices (1) at one end of pressure cabin 5, and a set of windmill generators (9) in series at the other end of pressure cabin 5.

There are multi air inlets (51) at one end of the said pressure cabin 5 and an air outlet at the other end (52). There is a control valve in air inlet 51 and another control valve (7) in air outlet 52 separately. When the air is sucked into air suction device 1, control valve 2 will open. and the air will enter into pressure cabin 5. (When air suction device 1 is not at work, control valve 2 will not open). Because that the pressure in pressure cabin 5 is greater than that in the serial-wound power generator unit (9), the compressed air in pressure cabin 5 will push open control valve 7 in air outlet 52. (If the pressure in pressure cabin 5 is equal to that in power-generating unit 9, control valve 7 will close automatically. However, if maintenance or reparation work should be done on the windmill generator unit (9), control valve 7 should be closed first to let maintenance personnel go into the equipment.

Moreover, the bottom end of air inlet 51 employs a trumpet shape, which facilitates the air flowing into pressure cabin 5; while the front end of air outlet 52 employs a contraction shape, which facilitates the compressed air rushing into the windmill generator unit (9).

There are a pressure gauge (4) and an exhaust valve (6) in pressure cabin 5, in which pressure gauge 4 can be used to check the inner pressure; while exhaust valve 6 employs a pressure release capacity to release out redundant air through it when the pressure in pressure cabin 6 reaches or exceeds the preset threshold, in order to ensure the safety of the invention.

The said air suction device comprises of an air-suction unit such as turbine machine, air compressor, or air pump. The windmill power generating set comprises of multiple fan-type windmill generators in series, which is fixed with bolt (83) and nut (84) (shown in FIG. 1) after the coupling between flange 81 at the back of a windmill generator and flange 82 at the front of the adjacent one. The coupling between a windmill generator (8) and the pressure cabin (5) is done with flanges 81 and 53, and is locked with bolt 83 and nut 84 (the same as that in FIG. 1). There is a mounting rack (13) in each windmill generator (8), and the main body (11) of windmill generator and its fans are fixed on mounting rack 13. furthermore, there is at least a windmill generator (8) has a manhole and a corresponding cover (18) instead of the mounting rack (13) and the main body (11). The location of the manhole on the windmill generator unit (9) depends on the actual requirement, with the principle that the maintenance personnel can carry out maintenance or reparation work as soon as he/she removes the bolts (17) of cover 18 and opens the cover.

In this invention, the windmill generator unit (9) comprises of multiple windmill generators in series, the total number of which ranges from several to several thousands, depending on the actual requirement. There is only an air outlet (19) on windmill generator unit (9), and once the compressed air enters into it, the main body (11) and the fans (12) of each windmill generator can be driven to revolve and generates power. Therefore, only one set of air suction device (1) is necessary to keep the windmill generator unit (9) generating power. In cases that more power is required, more air or additional air suction devices can be added. For example, when 5 million watt power is needed, only one set of air suction device is necessary; however, if 15 million watt power is needed, two or three sets of air suction devices can be used. Actually, the air needed varies little for several to several thousand windmill generators (8), because the windmill generator unit (9) employs one outlet and the air passing through it has little loss whether for several or several thousand windmill generators, though the air impedance may result in some side effect. The air input is fulfilled through the air suction devices (1), which consume power. However, the power generated from these windmill generators is multiple times of that consumed. That is to say, the power generated from windmill generator unit 9 is multiple times of that consumed by air suction device 1, which will not increase proportionally with the number of windmill generators added. Therefore this invention is absolutely beneficial in economy.

The operation procedures of this invention include: Before the air (20) is driven into pressure cabin 5 through the air suction device, the control valve (2) in air inlet (51) will open. The compressed air (21) bursting out pushes open the control valve (7) in the air outlet (52), and enters into the windmill generator unit (9) to drive the fans (12) to revolve, which in turn makes the main body (11) of a windmill generator generate power. Finally, the power generated from every windmill generator is sent to the line (15) of the collecting bar through line 14. Line 15 and line 15 are fixed together with at contact 16. Line 15 of the collecting bar sends the power to the rectifier to rectify and delivers the power to the electric network, and part of the power can also be sent to the air suction devices (1).

FIG. 4 demonstrates a parallel-wound embodiment of the invention. The embodiment in above FIG. 1 is a stand along one; however, the embodiment in this figure is a power-regenerating device with two or more sets of the serial-wound generators (100) wound in parallel. In this case, the two pressure cabins (5) are connected together, and the total number of air suction devices increases, which in turn increases the air input. In actual embodiments, all windmill generator sets can start simultaneously, or part of them start, with the remainder ones (9) in maintenance or reparation. When the pressure in pressure cabin 5 is too high, one or more air suction devices (1) can be switched off, and corresponding control valves (2) will close automatically; otherwise the air in pressure cabin 5 will leak out through control valves (2). When the pressure in pressure cabin 5 reaches the preset threshold and should be decreased but switching off an air suction device will result in insufficient pressure in pressure cabin 5, the exhaust valve (6) can be used to reduce the pressure and keep the entire system safe. This invention can not only implement self-sufficiency in electric power, but also deliver redundant power to other appliances. It brings great economical benefit without pollution to the environment, and is immune to ambient conditions and weather, meeting all requirements for a new and innovative patent. Therefore, I apply for a patent now with it.

Instruction of Legends

1 Air Suction Device

2 Control Valve

4 Pressure Gauge

5 Pressure Cabin

51 Air Inlet

52 Air Outlet

53 Flange

6 Exhaust Valve

7 Control Valve

8 Windmill Generator

81 Flange

82 Flange

83 Bolt

84 Nut

9 Serial-Wound Power Generator Set

11 Main Body of Power Generator

12 Fans

13 Motor Fixing Rack

14 OutputLine

15 Line of Collecting Bar

16 Contact

17 Bolt

18 Cover of Manhole

19 Air Outlet

20 Inbound Air Flow

21 Outbound Air Flow

100 Serial-Wound Power Regenerating Device

### BRIEF DESCRIPTION OF THE DRAWINGS

FIG. 1 is the exploded view of this invention.

FIG. 1A is the sketch map for the coupling between the flanges of two windmill generators.

FIG. 2 is a sectional view of the windmill generator.

FIG. 3 is the front view of the windmill generator.

FIG. 4 is the exploded view of a parallel-wound embodiment of this invention.

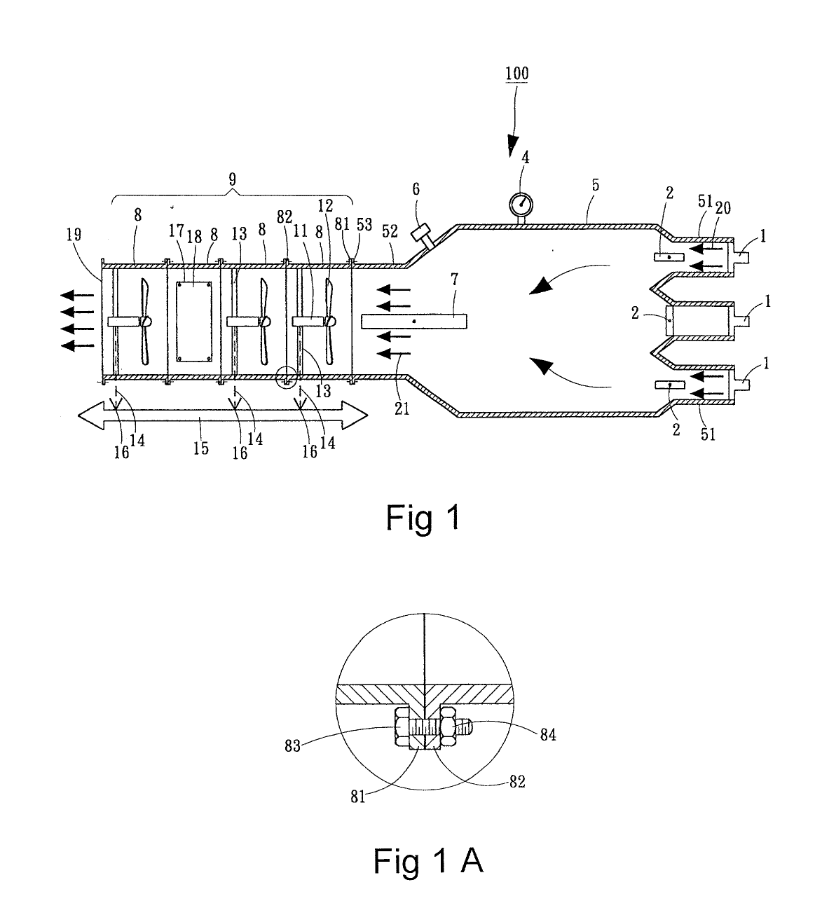

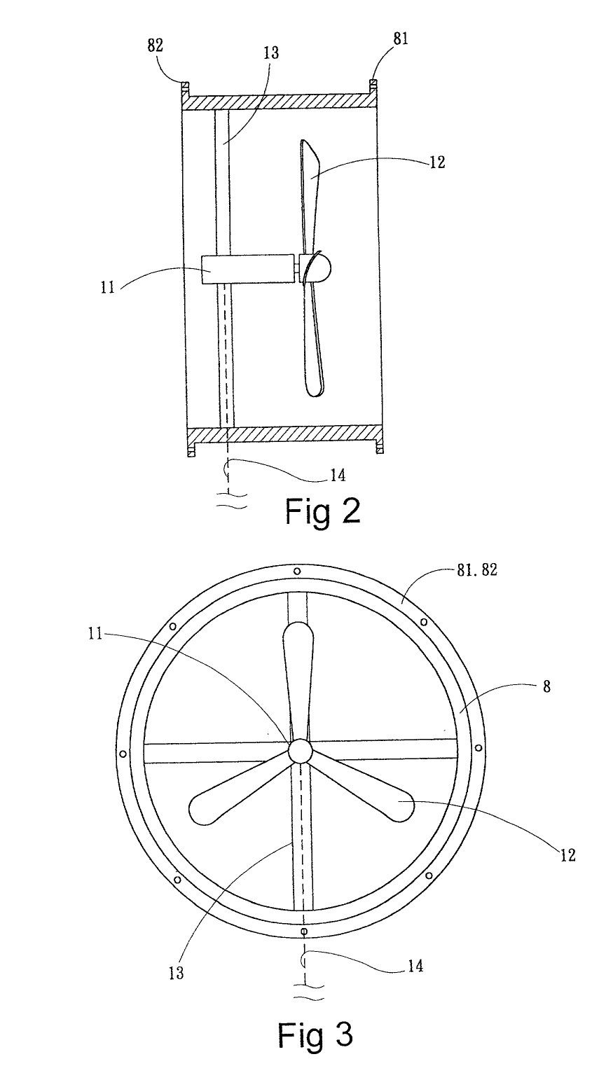

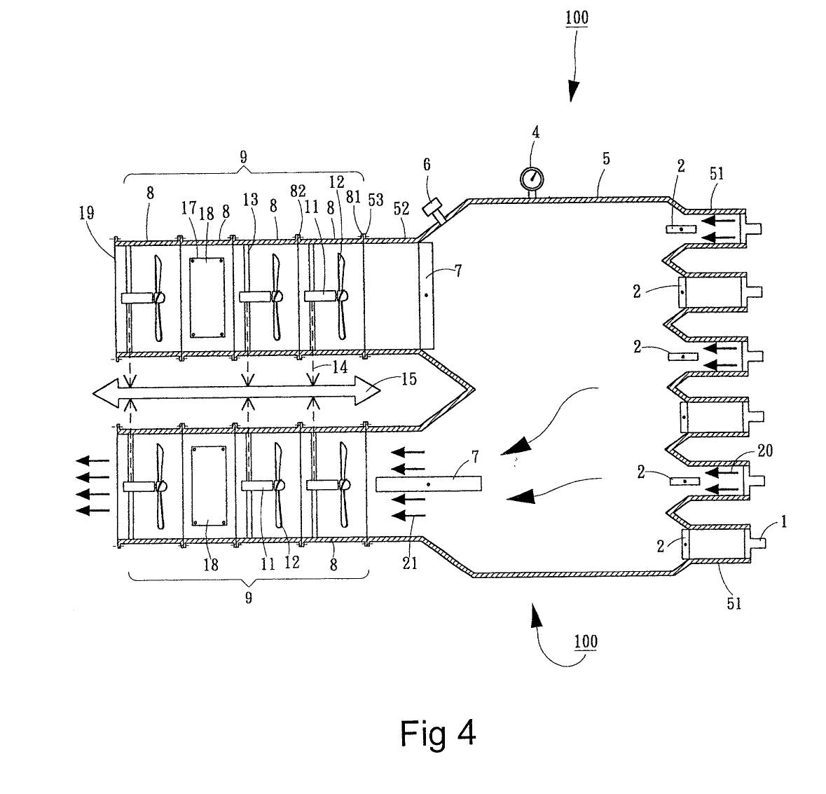

What is claimed is:

1. A serial-wound power-regenerating device, comprising of an airproof pressure cabin, one or more sets of air suction devices as air feeders at the inlets of the pressure cabin, and a power generator set composed of multiple fan-type windmill generators at the outlet of the pressure cabin; in which the air is sucked into the said pressure cabin through the said air suction device(s) and in turn enters into tile serial-wound power generator set to drive the fans to revolve, which makes the main body of each generators generates power; then the power is exported, rectified, and sent to the electric network or electric appliances; the invention is economically beneficial without any pollution to the environment.

2. The serial-wound power-regenerating device of claim 1, in which the said air-suction device is a turbine machine.

3. The serial-wound power-regenerating device of claim 1, in which the said air-suction device is an air compressor.

4. The serial-wound power-regenerating device of claim 1, in which the said air-suction device is an air blower.

5. The serial-wound power-regenerating device of claim 1, in which the said air-suction device is an air pump.

6. The serial-wound power-regenerating device of claim 1, in which the said pressure cabin and the said windmill generator is coupled with respective flange and is secured with bolts and nuts; while windmill generators are coupled and secured in the same way.

7. The serial-wound power-regenerating device of claim 1, in which a control valve lies in the inlet and the outlet of the said pressure cabin.

8. The serial-wound power-regenerating device of claim 1, in which an exhaust valve and a pressure gauge are equipped with the said pressure cabin.

9. The serial-wound power-regenerating device of claim 1, in which a motor mounting rack is devised in each windmill generator to mount the main body and the fans at the center of it; the power export lines are connected to the line of tile collecting bar.

10. The serial-wound power-regenerating device of claim 1, in which at least one windmill generator has a manhole and a corresponding cover on it to let the maintenance personnel in/out.

11. The serial-wound power-regenerating device of claim 1, in which the air outlet of the said pressure cabin employs a contraction shape.

12. The serial-wound power-regenerating device of claim 1, in which the pressure cabins are connected to each other when the device is implemented in a parallel-wound pattern.
